(19) United States
(12) Patent Application Publication
(10) Pub. No.: US 2010/0059906 A1
(43) Pub. Date: Mar. 11, 2010

(54) HIGH THROUGHPUT ELECTROBLOWING PROCESS

(75) Inventors: Gregory T. Dee, Wilmington, DE (US); Joseph Brian Hovanec, Richmond, VA (US); Jan Van Meerveld, Howald (LU)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/553,603

(22) Filed: Sep. 3, 2009

Related U.S. Application Data
(60) Provisional application No. 61/191,102, filed on Sep. 5, 2008.

(51) Int. Cl. B29C 47/08

(52) U.S. Cl. 264/465

(57) ABSTRACT

The present invention is a fiber spinning process comprising the steps of providing a polymer solution, which comprises at least one polymer dissolved in at least one solvent with a vapor pressure of at least about 6 kPa at 25° C., to a spinneret, issuing the polymer solution in combination with a blowing gas in a direction away from at least one spinning nozzle in the spinneret and in the presence of an electric field wherein the polymer solution is discharged through the spinning nozzle at a discharge rate between about 6 to about 100 ml/min/hole, forming fibers, and collecting the fibers on a collector.

### CROSS REFERENCE TO RELATED APPLICATIONS

Subject matter disclosed herein may be disclosed and claimed in the following application filed concurrently herewith, assigned to the assignee of the present invention:

“Fiber Spinning Process Using a Weakly Interacting Polymer”, Ser. No. 61/191,103 (Docket No. TK4955 US PRV), filed in the names of Dee, Hovanec, and VanMeerveld.

### FIELD OF THE INVENTION

The present invention relates to a process for forming a fibrous web from a high throughput electroblowing process.

### BACKGROUND

Solution spinning processes are frequently used to manufacture fibers and nonwoven fabrics, and in some cases have the advantage of high throughputs, such that the fibers or fabrics can be made in large, commercially viable quantities. These processes can be used to make fibrous webs that are useful in medical garments, filters and other end uses that require a selective barrier. The performance of these types of fibrous webs can be enhanced with the utilization of fibers with small diameters.

A type of solution spinning called electroblowing produces very fine fibers by spinning a polymer solution through a spinning nozzle in combination with a blowing gas and in the presence of an electric field.

However, it would be desirable to increase the throughput of this process to increase process efficiencies and lower the cost of manufacturing, without sacrificing fiber uniformity and product quality.

### SUMMARY OF THE INVENTION

The present invention is a fiber spinning process comprising the steps of providing a polymer solution, which comprises at least one polymer dissolved in at least one solvent with a vapor pressure of at least about 6 kPa at 25° C., to a spinneret, issuing the polymer solution in combination with a blowing gas in a direction away from at least one spinning nozzle in the spinneret and in the presence of an electric field wherein the polymer solution is discharged through the spinning nozzle at a discharge rate between about 6 to about 100 ml/min/hole, forming fibers, and collecting the fibers on a collector.

### BRIEF DESCRIPTION OF THE DRAWINGS

The accompanying drawing, which is incorporated in and constitutes a part of this specification, and together with the description, serves to explain the principles of the invention.

FIG. 1 is a schematic of a prior art electroblowing apparatus useful for preparing a fibrous web according to the invention.

### DETAILED DESCRIPTION OF THE INVENTION

The present invention relates to solvent-spun webs and fabrics for a variety of customer end-use applications, such as filtration media, energy storage separators, protective apparel and the like.

The present invention uses an electroblowing process to spin a polymer dissolved in a high vapor pressure solvent at a high rate of throughput into fibers and webs.

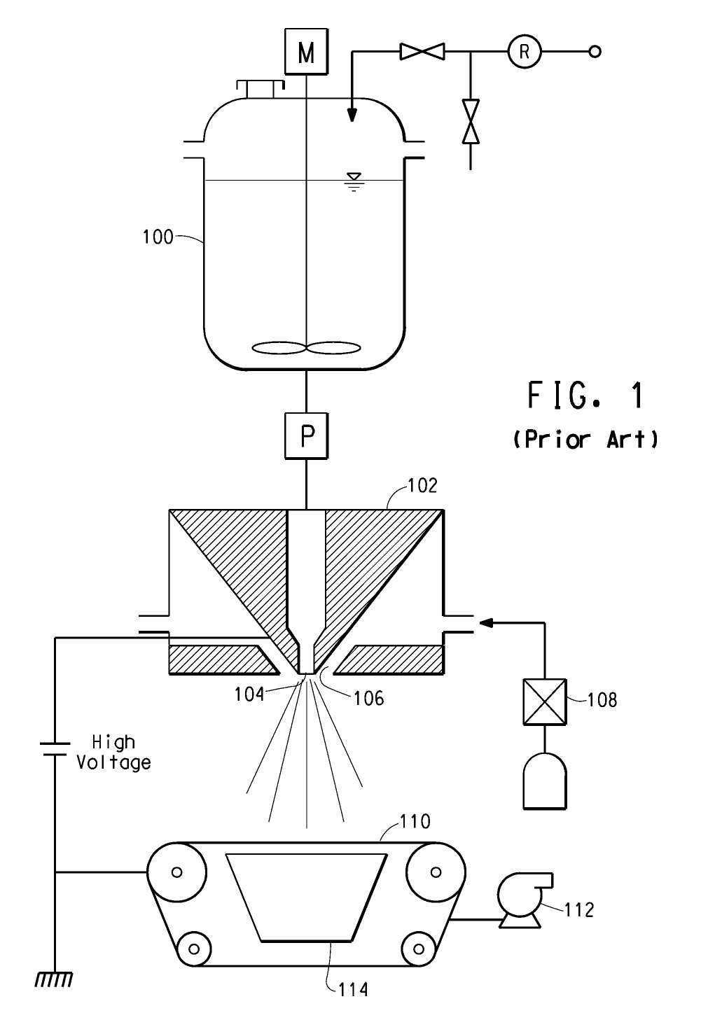

The process for making a fiber layer(s) is disclosed in International Publication Number WO2003/080905 (U.S. Ser. No. 10/822,325), which is hereby incorporated by reference. FIG. 1 is a schematic diagram of an electroblowing apparatus useful for carrying out the process of the present invention using electroblowing (or “electro-blown spinning”) as described in International Publication Number WO2003/080905. This prior art electroblowing method comprises feeding a solution of a polymer in a solvent from a storage tank 100, through a spinneret 102, to a spinning nozzle 104 to which a high voltage is applied, while compressed gas or blowing gas is directed toward the polymer solution through a blowing gas nozzle 106 as the polymer solution exits the spinning nozzle 104 to form fibers, and collecting the fibers into a web on a grounded collector 110 under vacuum created by vacuum chamber 114 and blower 112.

The collection apparatus is preferably a moving collection belt positioned within the electrostatic field between the spinneret 102 and the collector 110. After being collected, the fiber layer is directed to and wound onto a wind-up roll on the downstream side of the collector 110. Optionally, the fibrous web can be deposited onto any of a variety of porous scrim materials arranged on the moving collection belt, such as spunbonded nonwovens, meltblown nonwovens, needle punched nonwovens, woven fabrics, knit fabrics, apertured films, paper and combinations thereof.

Optionally, a secondary gas can contact the fibers downstream from the spinneret to help drive off solvent from the fiber. When electroblowing fibers with a high throughput rate, large quantities of solvent must be removed from the fiber forming polymer solution. The secondary gas can be positioned to impinge the fibers or can be used as a sweeping gas to help remove solvent from the general spinning area.

In order to spin fibers at high throughput or discharge rate, solvents with high vapor pressure can be used. According to the invention, solvents with vapor pressures of at least 6 kPa at 25° C. are preferred, of at least 10 kPa at 25° C. are more preferred and of at least 20 kPa at 25° C. are still more preferred. Suitable solvents with high vapor pressure include methanol (16.9), ethanol (7.9), acetone (30.8), butanone (12.1), dichloromethane (58.1), 1,2-dichloroethane (10.6), trifluoroacetic acid (14.7), ethyl acetate (12.4), tetrahydrofuran (21.6), chloroform (26), carbon tetrachloride (15.4), and hydrocarbons including pentane (68.3), hexane (20.2), heptane (6.1), cyclohexane (13), methylcyclohexane (6.1), and benzene (12.3), where the numbers in parentheses are the vapor pressures of these solvents at 25° C. in units of kPa. The vapor pressure data was obtained from “Organic Solvents”. Volume 2, fourth edition, by John Riddick, William Bunger, and Theodore Sakano, John Wiley & Sons, 1986 or from the DIPPR® database of physical properties of solvents.

According to the invention, solvents with vapor pressures of at least 6 kPa at 25° C. are preferred, of at least 10 kPa at 25° C. are more preferred and of at least 20 kPa at 25° C. are still more preferred.

The polymer solution can be spun at a temperature of about 0° C. to the boiling point of the solvent.

These solvents can be used to prepare polymer solutions that can be spun at a discharge rate between about 6 to about 100 ml/min/hole, more advantageously between about 10 to about 100 ml/min/hole, and most advantageously between about 20 to about 100 ml/min/hole.

The polymer(s) that can be used in making fiber layers in accordance with the process of the present invention are not particularly limited, provided that they are substantially soluble in the selected solvent at the desired concentration and can be spun into fibers by the process described herein. Examples of these polymers generally include hydrocarbon polymers. Examples of hydrocarbon polymers suitable for the present invention include polyolefins, polydienes, polystyrene and blends thereof. Examples polyolefins include polyethylene, polypropylene, poly(1-butene), poly(4-methyl-1-pentene), and blends, mixtures and copolymers thereof.

In addition to the forgoing polymers, other examples include polysulfones, polycarbonates, poly(meth)acrylates, cellulose esters, polyvinylchlorides, and blends thereof. Examples of poly(meth)acrylates include polymethylacrylate and polymethylmethacrylate. Examples of cellulose esters include cellulose triacetate. Examples of polyesters include polyethylene therephthalate, polypropylene therephthalate, polybutylene therephthalate, poly(epsilon-caprolactone), poly(DL-lactic acid) and poly(L-lactide).

The blowing gas can be selected from the group of air, nitrogen, argon, helium, carbon dioxide, hydrocarbons, halocarbons, halohydrocarbons and mixtures thereof. The blowing gas is injected at a flow velocity of about 50 to about 340 m/sec and a temperature from about ambient to about 300° C.

The fibers produced have a number average fiber diameter preferably less than 1,000 nanometers, more preferably less than 800 nanometers and most preferably less than 500 nanometers. The fibers can be continuous or discontinuous. The fibers can have an essentially round cross section shape.

The electric field can have a voltage potential of about 10 to about 100 kV. The electric field can be used to create a corona charge.

The fibers can be collected into a fibrous web comprising round cross section, weakly interacting polymer fibers having a number average fiber diameter less than about 1,000 nanometers.

The secondary gas can be selected from the group of air, nitrogen, argon, helium, carbon dioxide, hydrocarbons, halocarbons, halohydrocarbons and mixtures thereof. The secondary gas is injected at a flow velocity of about 50 to about 340 m/sec and a temperature from about ambient to about 300° C.

### Test Methods

Fiber Diameter was determined as follows. Two to three scanning electron microscope (SEM) images were taken of each fine fiber layer sample. The diameter of clearly distinguishable fine fibers were measured from the photographs and recorded. Defects were not included (i.e., lumps of fine fibers, polymer drops, intersections of fine fibers). The number average fiber diameter from about 50 to 300 counts for each sample was calculated.

### EXAMPLES

The fiber examples below were prepared using the general process and apparatus described above with the specific changes as noted below.

### Example 1

A 9 wt % solution of polymethylmethacrylate (PMMA) was dissolved in acetone (vapor pressure of 24.2 kPa at 25° C.) at room temperature. A magnetic stirrer was used to agitate the solution. The homogeneous solution was transferred to a sealed glass container and transported to the spin chamber. The solution was transferred into the reservoir of the spin chamber and sealed. A spinneret with a 0.254 mm inside diameter single spinning nozzle was used. A drum collector was used to collect the sample. The spinneret was placed at a negative potential of 100 kV. The collector was grounded. The distance from the spinning nozzle exit to the collector surface was 51 cm. Air was used for the blowing gas. Nitrogen was used for the secondary gas to control the relative humidity and the temperature in the spin chamber. The flow of nitrogen was sufficient to avoid the concentration of the solvent vapor in the spin chamber exceeding the lower explosion limit. The relative humidity was controlled to be less than 11%. The spin chamber temperature was close to 23° C. for the duration of the experiment. A nitrogen pressure of 0.2044 MPa was used to maintain a solution flow rate of 6.7 ml/min/hole. The blowing gas was controlled to maintain an exit velocity on the order of 67 m/sec. The blowing gas temperature was close to 23° C. Fiber was visible in the plume soon after the solution flow was initiated. Fiber was deposited in a swath on the drum. The number average fiber diameter of the fibers was measured to be 393 nanometers.

### Example 2

A 9 wt % solution of polystyrene was dissolved in dichloromethane (vapor pressure of 58.1 kPa at 25° C.) at room temperature. A magnetic stirrer was used to agitate the solution. The homogeneous solution was transferred to a sealed glass container and transported to the spin chamber. The solution was transferred into the reservoir of the spin chamber and sealed. A spinneret with a 0.406 mm inside diameter single spinning nozzle was used. A drum collector was used to collect the sample. The spinneret was placed at a negative potential of 100 kV. The collector was grounded. The distance from the spinning nozzle exit to the collector surface was 95 cm. Air was used for the blowing gas. Air was used for the secondary gas to control the relative humidity and the temperature in the spin chamber. The flow of air was sufficient to avoid the concentration of the solvent vapor in the spin chamber exceeding the lower explosion limit. The relative humidity was controlled to be less than 11%. The spin chamber temperature was close to 32° C. for the duration of the experiment. A nitrogen pressure of 0.515 MPa was used to maintain a solution flow rate of 34.3 ml/min/hole. The blowing gas was controlled to maintain an exit velocity on the order of 150 m/sec. The blowing gas temperature was close to 24° C. Fiber was visible in the plume soon after the solution flow was initiated. Fiber was deposited in a swath on the drum. The number average fiber diameter of the fibers was measured to be 335 nanometers.

### Example 3

A 9 wt % solution of polystyrene was dissolved in dichloromethane (vapor pressure of 58.1 kPa at 25° C.) at room temperature. A magnetic stirrer was used to agitate the solution. The homogeneous solution was transferred to a sealed glass container and transported to the spin chamber. The solution was transferred into the reservoir of the spin chamber and sealed. A spinneret with a 0.406 mm inside diameter single spinning nozzle was used. A drum collector was used to collect the sample. The spinneret was placed at a negative potential of 100 kV. The collector was grounded. The distance from the spinning nozzle exit to the collector surface was 114 cm. Air was used for the blowing gas. Air was used for the secondary gas to control the relative humidity and the temperature in the spin chamber. The flow of air was sufficient to avoid the concentration of the solvent vapor in the spin chamber exceeding the lower explosion limit. The relative humidity was controlled to be less than 11%. The spin chamber temperature was close to 37° C. for the duration of the experiment. A nitrogen pressure of 0.77 MPa was used to maintain a solution flow rate of 57.1 ml/min/hole. The blowing gas was controlled to maintain an exit velocity on the order of 150 m/sec. The blowing gas temperature was close to 24° C. Fiber was visible in the plume soon after the solution flow was initiated. Fiber was deposited in a swath on the drum. The number average fiber diameter of the fibers was measured to be 630 nanometers.

### Example 4

An 11 wt % solution of Engage 8400 (an ethylene octene copolymer), available from DuPont, was dissolved in methylcyclohexane (vapor pressure of 6.1 kPa at 25° C.) using a reflux condenser. A magnetic stirrer was used to agitate the hot solution. The homogeneous solution was transferred to a sealed glass container and transported to the spin chamber. The solution was transferred into the reservoir of the spin chamber and sealed. A spinneret with a 0.4064 mm inside diameter single spinning nozzle was used. A drum collector was used to collect the sample. The spinneret was placed at a negative potential of 100 kV. The collector was grounded. The distance from the spinning nozzle exit to the collector surface was 30 cm. Air was used for the blowing gas. Nitrogen was used for the secondary gas to control the relative humidity and the temperature in the spin chamber. The flow of nitrogen was sufficient to avoid the concentration of the solvent vapor in the spin chamber exceeding the lower explosion limit. The relative humidity was controlled to be less than 9%. The spin chamber temperature was close to 29° C. for the duration of the experiment. A nitrogen pressure of 0.308 MPa was used to maintain a solution flow rate of 12.6 ml/min/hole. The blowing gas was controlled to maintain an exit velocity on the order of 156 m/sec. The blowing gas temperature was close to 28° C. Once the solution flow was initiated, fiber was visible in the plume. Fiber was deposited in a swath on the drum. The number average fiber diameter of the fibers was measured to be 502 nanometers.

What is claimed is:

1. A fiber spinning process comprising:
providing a polymer solution, which comprises at least one polymer dissolved in at least one solvent with a vapor pressure of at least about 6 kPa at 25° C., to a spinneret;
issuing the polymer solution in combination with a blowing gas in a direction away from at least one spinning nozzle in the spinneret and in the presence of an electric field wherein the polymer solution is discharged through the spinning nozzle at a discharge rate between about 6 to about 100 ml/min/hole;
forming fibers; and
collecting the fibers on a collector.

2. The process according to claim 1, wherein the solvent is selected from the group consisting of methanol, ethanol, acetone, butanone, dichloromethane, 1,2-dichloroethane, trifluoroacetic acid, ethyl acetate, tetrahydrofuran, chloroform, carbon tetrachloride, and hydrocarbons.

3. The process according to claim 2, wherein the hydrocarbons are selected from the group consisting of pentane, hexane, heptane, cyclohexane, methylcyclohexane, and benzene.

4. The process according to claim 1, wherein the vapor pressure is of at least about 10 kPa at 25° C.

5. The process according to claim 1, wherein the vapor pressure is of at least about 20 kPa at 25° C.

6. The process according to claim 1, wherein the polymer solution is discharged through the spinning nozzle at a discharge rate between about 10 to about 100 ml/min/hole.

7. The process according to claim 6, wherein the polymer solution is discharged through the spinning nozzle at a discharge rate between about 20 to about 100 ml/min/hole.

8. The process according to claim 1, wherein the blowing gas is selected from the group of air, nitrogen, argon, helium, carbon dioxide, hydrocarbons, halocarbons, halohydrocarbons and mixtures thereof.

9. The process according to claim 1, wherein the blowing gas is injected at a flow velocity of about 50 to about 340 m/sec and a temperature from about ambient to about 300° C.

10. The process according to claim 1, wherein the fibers have a number average fiber diameter less than about 1000 nanometers.

11. The process according to claim 10, wherein the fibers have a number average fiber diameter less than about 800 nanometers.

12. The process according to claim 11, wherein the fibers have a number average fiber diameter less than about 500 nanometers.

13. The process according to claim 1, wherein the electric field has a voltage potential of about 10 kV to about 100 kV.

14. The process according to claim 1, wherein the electrical field is a corona charging field.

15. The process according to claim 1, wherein the fibers have a cross section shape that is essentially round.

16. The process according to claim 1, further comprising contacting the fibers with a secondary gas located downstream from the spinneret.

17. The process according to claim 16, wherein the blowing gas is selected from the group of air, nitrogen, argon, helium, carbon dioxide, hydrocarbons, halocarbons, halohydrocarbons and mixtures thereof.

18. The process according to claim 16, wherein the blowing gas is injected at a flow velocity of about 50 to about 340 m/sec and a temperature from about ambient to about 300° C.

19. The process according to claim 1, wherein said at least one polymer in said polymer solution is selected from the group consisting of polyolefins, polydienes, polystyrene, polysulfones, polycarbonates, poly(meth)acrylates, cellulose esters, polyvinylchlorides and blends thereof.
